(19) United States
(12) Patent Application Publication
(10) Pub. No.: US 2008/0186170 A1
(43) Pub. Date: Aug. 7, 2008

(54) Dishwasher Provided with a Spray Arm

(75) Inventor: Wolfgang Schleifer, Erlangen (DE)

Correspondence Address: PEARNE & GORDON LLP, 1801 EAST 9TH STREET, SUITE 1200, CLEVELAND, OH, 44114-3108, US

(73) Assignee: Electrolux Home Products Corporation N.V., Zaventem (BE)

(21) Appl. No.: 12/067,706

(22) PCT Filed: Sep. 29, 2006
(86) PCT No.: PCT/EP2006/009458

§ 371 Date: Mar. 21, 2008

(30) Foreign Application Priority Data
Sep. 30, 2005 (DE) 102005046803.9

(51) Int. Cl. G08B 21/00

(52) U.S. Cl. 340/540

(57) ABSTRACT

The invention relates to a dishwasher (1) provided with at least one spray arm (9, 13) and a detection device (30) for detecting the rotation and/or presence of at least one spray arm (9, 13). According to said invention, the detection device (30) is embodied in the form of a transmitter/receiver device used for emitting and receiving electromagnetic radiation waves and at least one spray arm (9, 13) is provided with at least one transponder element (32, 34), in particular a RFID transponder element. An electrical household appliance (1) comprising a component (9, 13, 19) marked by means of the transponder element (32, 34, 36) and possibly detected thereby is also disclosed.

The invention concerns a dishwashing machine with a sensing device for detecting the rotation of a spray arm, a spray arm for such a device and a household device with an instrument for detection of the presence of components of the household device.

A dishwashing machine with a position sensor for detecting the rotation speed and position of a spray arm is known from DE 101 21 083 A1. At the tip of the spray arm a permanent magnet is provided, and a Hall sensor is arranged in the clear rinse metering device which senses the permanent magnet at the tip of the spray arm. If the spray arm passes close to the metering device during its rotation, the Hall sensor triggers a signal, on the basis of which the rotation or rotation speed of the spray arm is determined.

It is the task of the invention to devise a dishwashing machine, a household apparatus and a spray arm for use in a dishwashing machine which permits a reliable and robust detection of a component of the household device and of a spray arm of the dishwashing machine in a simple way.

This problem is solved by the features of claims 1, 7 and 16.

Advantageous variants are the subject of the subordinate claims

The above-described use of Hall sensors and permanent magnets for sensing the rotation of a spray arm, on the one hand, has the disadvantage that the range of a Hall sensor is very limited, and on the other hand, that the mounting and encapsulation of a permanent magnet on the spray arm to prevent corrosion of the permanent magnets in the dishwashing machine atmosphere is very costly. For example, if the spray arm is adjustable in height, the positioning of the spray arm with the Hall sensor may be difficult. In addition, the flexibility is limited, e.g., due to the fact that a single Hall sensor cannot distinguish between two magnets arranged on different components

According to claim 1, the dishwashing machine has a sensing device which includes a transmitting/receiving device that can transmit electromagnetic waves to a transponder element and receive a response signal from the transponder element. The transmitting part and receiving part of the sensing device in this case may be arranged in different places or in the same place. The transponder elements are arranged on the spray arm and may itself be designed as an extremely simple, passive element or as an active element. For example, the passive element is excited by the frequency of the transmitting device and, due to the excitation, sends a response signal of the same or another frequency to the receiving device of the sensing apparatus. An active element can receive either a simple excitation from the transmitting device or a complex series of signals which is then also answered with a complex series of signals or a response on different frequencies so that the sensing device can distinguish between different transponder elements on the basis of the signal emitted by the transponder element. An example of this is an RFID (Radio Frequency Identification) transponder element with which an identification of the transponder element is identified [sic] either via an excitation to an especially tuned transponder element or via a special series of signals emitted by the transponder element or the frequency of the transponder of the transponder element. When such a transponder element is used, for example, the spray arm or another component of a household device (see below) can be identified.

Transponder elements are available, e.g., as glued-on labels, in which case through the appropriate choice of the adhesive and the material of the label of the transponder element its use is possible in the harsh atmosphere of the washing compartment of the dishwashing machine. For example, a passive transponder element consists only of metallic conductors as antenna and simple resistor or capacitor elements. Neither the space requirement nor the weight of transponder elements are significant so that an already existing spray arm type can be provided with a transponder element directly and without causing an imbalance.

The rotation of the spray arm is especially advantageously detected by having the reception or transmission of the transponder elements dependent on direction so that the receiving device of the sensing apparatus cannot detect a response signal on the transponder elements in every rotational position of the spray arm and therefore, because of a time variation of the detection/non-detection the response of the transponder elements to the rotational position and therefore the rotation of the spray arm can be concluded in retrospect. Alternatively or additionally the transmitting/receiving system is constructed from a detection/sensing device and transponder in such a way that the transponder cannot be detected in every spatial position inside the washing compartment of the dishwashing machine but rather only when it remains in a limited spatial range near the sensing device. In the case of a separate arrangement of the transmitting and receiving devices of the sensing apparatus, the limited spatial range may relate either to transmission to the transponder or to reception from the transponder. In this case it is advantageous to establish the spatial dependence in such a way that the transponder cannot be sensed in every position of the spray arm. Here also again during the rotation a time sequence of detecting/non detecting of the transponder is achieved, on the basis of which it is possible to draw conclusions regarding the rotation of the spray arm.

The transmitting and/or receiving capacity of the transmitting/receiving device is quite especially advantageously variable so that the detectability of the transponder element is also variable in space or position. In this way, for example, in the case of high transmitting or receiving capacity/power the transponder element can be detected over greater distances or in every angular position, while in the case of low transmitting or receiving power only certain angular positions or spatial distances to that transponder element are detected. As a result, for example, a function test or a presence test can be conducted at high power, in which the communication power of the detection device is tested and at the same time the presence of the transponder element or of the spray arm. The same is true when applied to a household device in general for sensing the presence of a component provided with a transponder. If the configuration and function tests can be completed at a higher power, one can then reduce to lower power in order to detect a relative position of the transponder element, i.e. for example, the variable distance of the transponder element during the spray arm rotation or the variable angular position in that case. Advantageously, for example, the power is also increased if a large quantity of dishwashing liquid is circulating inside the washing compartment and the damping of the electromagnetic waves inside the washing chamber is increased.

In the case of the household device according to claim 7, the presence of a component of the household device is verified by providing the corresponding component with a transponder element and querying the presence of the transponder element by means of the transmitting/receiving device. The above-made remarks and variations concerning the transponder element and the transmitting/receiving device as well as the sensing device are applicable here also by analogy. The detection of components of the household device facilitates the operation of the household device for the user, because the configuration of the household device does not have to be input, or only partially, if for example, programs or functions of the household device depend on the presence/absence of this/these component(s).

Quite especially advantageously the household device includes a control device which receives a recognition signal from the transmitting/receiving device, on the basis of which the control device automatically registers the configuration of the household device and if necessary operates a program or function of the household device as a function of the presence/absence of the individual components. In this case, preferably, individualizing transponder elements are provided so that the transmitting/receiving device can recognize different types of transponder elements and thereby the presence/absence of several different components in or on the household device.

In the case of the spray arm according to claim 16 the transponder element is advantageously already integrated in the spray arm material. For example, during an injection molding process, the transponder element is incorporated permanently in the spray arm material so that a permanent and corrosion-resistant connection of the transponder element to the spray arm is provided.

It is generally envisioned that the components of a household device be provided with a transponder element so that the latter may be used, e.g., as theft proofing in a warehouse. If a self-identifying transponder element is used (see above), then it is possible to require different models of a household device that are assembled on the same assembly line and different components as a function of the model that identify the components on the basis of a transmitting/receiving device. In this way it can be assured that the correct component is installed in the correct model. As a result with the transponder element one can not only detect the position of the spray arm in a dishwashing machine and detect a component in a household device but also have theft proofing and/or component identification during assembly.

One variant of the invention is explained in more detail by the figures. They show:

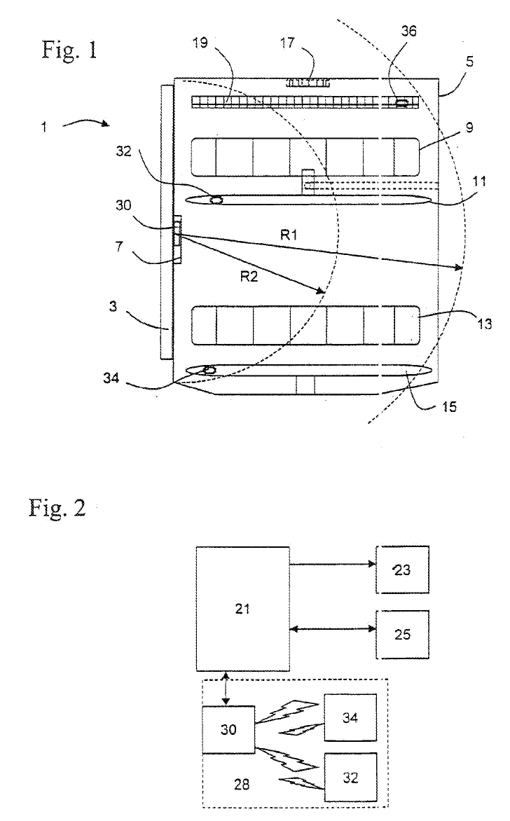

FIG. 1. A schematic arrangement of components in a dishwashing machine, and

FIG. 2. A block diagram of the control of a dishwasher machine of FIG. 1

FIG. 1 shows schematically a cross-section through an inner chamber of the dishwashing machine 1. In a washing compartment 5 of the dishwashing machine 1 an upper dish basket 9, and upper spray arm 11, a lower dish basket 13 and a lower spray arm 15 are arranged. Above the upper dish basket 9 a retractable cutlery/utensil basket 19 is arranged, toward which a spray jet is directed from a rotatably mounted top sprayer 17. Toward the front side, the washing compartment 5 can be closed by a door 3 in which in metering device 7 is arranged for the clear rinse and the dishwashing detergent.

As part of a communication device 28, an RFID reader 30 is arranged in the metering device 7 behind the a housing wall of the metering device 7. The housing wall of the metering device 7 shields the RFID reader 30 against the spray jets, while electromagnetic waves (radio waves) pass through the plastic wall to the interior of the washing compartment 5 and radio waves can be received from it.

The first transponder 32 and a second transponder 34 are arranged on the spray arms 11, 15 radially offset to the axis of rotation of the upper and lower spray arms 11, 15. In the variant shown, the transponders 32, 34 have RFID tags (adhesive labels) glued to them with a special glue and whose foil (e.g., polyamide) is resistant to the atmosphere of the washing compartment. A third transponder 36 is mounted in the rear region of the cutlery [eating utensil] basket 19.

To respond to a querying signal from the RFID reader 30 the three transponders 32, 34, 36 in each case transmit a variable response signal that is detectable by the receiving part of the RFID reader 30. The detectability depends on whether the transponders respond to the querying signal at all (are able to respond) or whether the power received by the transponders is sufficient for the response signal to be received by the transponders 32, 34, 36 of the reader 30. As is described further below, the transmitting power of the reader 30 can be adjusted so that in the case of increased transmitting power the response to the transponders 32, 34, 36 is assured in every case regardless of the distance or alignment of the transponder with respect to the reader 30. This case is symbolized in FIG. 1 by the reading range shown as a broken line with the radius R1. In the event of a reduced transmitting power of the reader 30, the secure detectability of the transponders is reduced to the reading range shown by the broken line, symbolized with the communication radius R2. The reading range is represented only greatly simplified in FIG. 1, and it goes without saying that the actual reading range inside the interior space of a washing compartment 5 is far more complicated because of reflections and vibrating elements inside the washing compartment.

FIG. 2 shows a block diagram of the control of a dishwasher machine of FIG. 1. A controller 21 controls the dishwashing machine as a function of the options set by the user and the signals received from the various sensors of the dishwashing machine (conventional sensors not shown). Program options can be input by the user via an input panel 25 connected to the controller 21. The controller 21 shows the operating states or program option choices on a display 23. The controller 21 is also connected to the communication device 28 which includes the reader 30 and the transponders that can be read by the reader (here the transponders 32, 34, 36 of FIG. 1). The transponders 32, 34, 36 are distinguished by a time-offset transmission of signals with three different transmission frequencies by the reader 30. The transponders that can be excited by the special frequency in each case answers upon receiving the excitation frequency with a response signal that is detected by the reader 30 to the extent that transmitting power, alignment of the transponder and distance from the transponder to the reader 30 or receiving a response signal by the reader 30 are sufficient.

At the beginning of the program, the reader 30 transmits with higher power so that even the more remotely situated transponder element 36 of the cutlery basket 19 will receive a response signal. With the increased transmitting power the presence of all three transponders 32, 34, 36 is detected. If one of the transponders 32 or 34 should be absent, a corresponding error signal is displayed on the display 23. If a response signal on transponder 36 is missing, the controller 21 assumes that no cutlery baskets 19 is present in the washing compartment 5, and therefore no special program for cleaning cutlery situated in the cutlery basket 19 needs to be called up or run through. In this case either the top sprayer 17 is not supplied with cleaning fluid, or a separate washing step is omitted in which only the top sprayer 17 is supplied with cleaning fluid for intensive cleaning of the cutlery.

During the rinsing operation, then the reader transmits with intermediate transmitting power, in which case only the presence of the transponders 32 and 34 is queried. If cleaning fluid is sprayed by the corresponding spray arm 11, 15, the latter should be rotating so that the response signal is detected by the corresponding transponder 32, 34 only at those times when the detection is permitted by the reduced reading range (radius R2). If either no response signal at all or a response signal of one of the transponders 32, 34 is constantly detected in such a program segment, although rotation of the spray arm 11 and/or 15 is anticipated in the corresponding program segment, then a corresponding error signal is displayed.

### List of Reference Symbols

1 dishwashing machine
3 door
5 washing compartment
7 metering device
9 upper dish basket
11 upper spray arm
13 lower dish basket
15 lower spray arm
17 top sprayer
19 cutlery basket
21 controller
23 display
25 input panel
28 communications device
30 RFID reader
32 first transponder
34 second transponder
36 third transponder
R1,R2 ranges

1. Dishwashing machine with at least one spray arm (9, 13) and a detection or sensing device (30) for detecting the rotation and/or the presence of at least one of the spray arms,
characterized in that
the detection device (30) displays a transmitting/receiving device (30) for transmitting and receiving electromagnetic waves, and
which has at least one spray arm (9, 13), at least one transponder element (32, 34), especially an RFID transponder element.

2. Dishwashing machine as in claim 1, in which the reception of the signal transmitted by the transmitting/receiving device (30) by the transponder element (32, 34) and/or the reception of the response signal transmitted by the transponder element by the transmitting/receiving device is dependent on the spatial alignment of the transponder element (32, 34) with respect to the transmitting/receiving device (30) and/or on the distance between the transponder element and the transmitting/receiving device.

3. Dishwashing machine as in claim 1 in which the transmitting and/or receiving power of the transmitting/receiving device (30) is so set or adjustable that the transponder element (32, 34) can be detected only in pre-assigned angular position regions of the spray arm (9, 13).

4. Dishwashing machine as in claim 1 in which the transponder elements (32, 34) are arranged radially at a distance from the axis of rotation of the spray arm (9, 13), and the transmitting and/or receiving power of the transmitter/receiver (30) is so set or adjustable that the transponder element is only detectable inside a pre-assigned distance range from the transmitter/receiver.

5. Dishwashing machine as in claim 1, in which the transmitting and/or receiving power of the transmitter/receiver (30) is variable as a function of an operating mode of the dishwashing machine (1).

6. Dishwashing machine as in claim 1 in which the transmitting and/or receiving power of the transmitter/receiver (30) is variable as a function of the quantity of cleaning fluid circulating.

7. Household device, especially a dishwashing machine (1) with a transmitting/receiving device (30) for transmitting and receiving electromagnetic waves, in which, by means of the transmitting/receiving device (30) the presence of at least one component (9, 13, 19) of the household device marked by at least one transponder element (32, 34, 36) can be detected, especially a component marked by at least one RFID transponder element

8. Household device or dishwashing machine (1) which displays a control device (21) for controlling a program of the household device or dishwashing machine, as transmitting/receiving device (30) being connected to the controlling device (21) and via the connection, a recognition signal can be transmitted from the sending/receiving device to the control device.

9. Household device or dishwasher machine (1) as in claim 8, in which the control device (1) runs a program as a function of the recognition signal.

10. Household device or dishwashing machine as in claim 8, in which the program options available to the user can be varied by the control device (21) as a function of the recognition signal.

11. Household device or dishwashing machine (1) as in claim 7, in which the signal transmitted by a transponder element (32, 34, 36) differs from the signal of at least one other transponder element.

12. Household device or dishwashing machine (1) as in claim 7, in which, depending on the signal transmitted by the transmitting/receiving device (30) a first or at least one other transponder element (32, 34, 36) can respond selectively.

13. Household device or dishwashing machine (1) as in claim 7, in which the transmitting/receiving device transmits on different frequencies and/or transmits different signal sequences.

14. Household device or dishwashing machine (1) as in claim 7 in which the transponder element (32, 34) is glued onto at least one spray arm (9, 13) or is mounted in the spray arm, especially injection molded in the spray arm material.

15. Household device or dishwashing machine (1) as in claim 7 one of the foregoing claims, in which, the transponder element (34, 36), can be detected by means of at least one other transmitting/receiving device.

16. Dishwashing machine spray arm (9, 13) with a transponder element (32, 34), especially a transponder element in which the transponder element is glued onto the spray arm or is mounted in the spray arm, especially injection molded into the spray arm material.
